(19) United States
(12) Patent Application Publication
(10) Pub. No.: US 2021/0184418 A1
(43) Pub. Date: Jun. 17, 2021

(54) MANUFACTURING OF OPTICAL FIBERS WITH SYMMETRY-BREAKING LONGITUDINAL PROTRUSIONS

(71) Applicant: CORACTIVE HIGH-TECH INC., Québec (CA)

(72) Inventors: Bertrand MORASSE, Québec (CA); Yann VASSEUR, Québec (CA); David FORTIN-MAGNAN, Québec (CA)

(73) Assignee: CORACTIVE HIGH-TECH INC., Québec (CA)

(21) Appl. No.: 16/079,920

(22) PCT Filed: Feb. 26, 2016
(86) PCT No.: PCT/CA2016/050203

§ 371 Date: Aug. 24, 2018

(51) Int. Cl. H01S 3/067; H01S 3/16

(52) U.S. Cl. CPC H01S 3/06733; H01S 3/1601

(57) ABSTRACT

A method of manufacturing an optical fiber is provided. The method involves providing a fiber preform with an active core and a pump-guiding cladding, and assembling one or more side rods to the fiber preform. The side rods extend longitudinally along an outer surface of the pump-guiding cladding. The resulting fiber preform assembly is drawn into the optical fiber. Each side rod defines a longitudinal protrusion extending along the optical fiber. Each longitudinal protrusion may have a cross-section forming a middle bump projecting radially away from the outer surface of the pump-guiding cladding and smooth transition regions with this outer surface of the pump-guiding cladding on opposite sides of the middle bump.

### TECHNICAL FIELD

The technical field generally relates to optical fibers and more particularly to the manufacturing of double clad optical fibers or the like in which a cladding-guided pump light beam is to be coupled into the core of the fiber.

### BACKGROUND

Optical fibers having an active core can be used as light emitting devices. For this purpose, the core of the optical fiber can be doped with an active ion, for instance a rare-earth element such as thulium, ytterbium, erbium neodymium or a combination of them, which is used to produce a stimulated emission of photons from the dopant ions in the doped optical fiber. Such optical fibers can be used in a light emitting device such as a laser or amplifier configuration.

There is a need for light emitting devices with good beam quality that provide a long working distance with a high power density. The beam quality is often measured in term of a dimensionless parameter called the M² factor which can take a value of 1.0 or higher, a M² factor of 1.0 indicating a perfect Gaussian beam with a good beam quality. The higher the M² factor, the smaller the beam can be focused or collimated and the longer the Rayleigh range, which is the distance along which the beam remains focused.

Light travelling in an optical fiber propagates mostly through guiding along the core. In order to obtain a good beam quality out of a fiber laser or amplifier, the dimensions of the core of the optical fiber are often restricted to small dimensions to guide only one or a few modes. Although the fundamental or the first few guided modes are typically the ones with the lower M² factor, having a small core restricts the amount of energy or power that can be injected in the core to pump the active ions, which in turn limits the output power of the light emitting device. A solution to this issue is to use a double cladding optical fiber, where the pump energy is injected in a large cladding while the output signal is generated or amplified in the core. This allows the coupling of a large amount of pump power in the cladding of the optical fiber while promoting a good beam quality from the smaller core.

The trade-off of double cladding fibers is that the absorption of the pump power is reduced since active ions are mostly confined in the core or closed to it. This requires a longer piece of fiber to absorb pump power, which can increase non-linear effects generated in the fiber. The cladding pump absorption, defined as the absorption of the pump light injected in the cladding at a given wavelength, typically scales with the core area dived by the cladding area as per the following equation:

$$Cladding pump absorption = \frac{dopant area}{cladding area} * dopant absorption$$

In the case where the active dopant is put uniformly in the core, the equation above translates as follow:

$$Cladding pump absorption = \frac{core area}{cladding area} * core absorption$$

One skilled in the art will readily understand that the equations above are simplified to show the general trend of pump absorption in double-clad optical fibers. The form presented above makes several assumptions, including a uniform pump power injected throughout the cladding and a uniform dopant area. A more exact calculation would require the exact overlap factor of each pump mode to the exact dopant profile. Although the light circulating in the cladding is referred to herein as “pump” light, it will be readily understood that the same principles would apply to a signal light or any light injected in the cladding of the double cladding fiber.

Optical fibers are generally made with a circular cross-section. For double-clad fibers, this is very detrimental to the absorption, by the core dopants, of the pump light injected in the cladding. The circularity of the fiber generates cladding modes that does not intersect with the doped core, which means that several modes of the pump power are not absorbed by the core and therefore do not contribute to light amplification or generation. Such non-absorbed modes are often referred to as “helical rays” or “helical modes”. In these circumstances cladding pump absorption is mitigated by an absorption factor A as follow:

$$Cladding pump absorption = \frac{core area}{cladding area} * A * core absorption$$

The absorption factor A can vary between 0 and 1, where 1 signifies an absence of helical modes and 0 a case where all the pump power is in helical modes and there would be no cladding pump absorption. Tests conducted by the inventors have shown that typical circular optical fibers are characterised by an absorption factor as low as 0.2, which signifies that only 20% of the injected pump power intersect with the doped core and can be used for light amplification or generation, even if a long piece of fiber is used. Indeed, the absorption factor can vary depending on the length of the optical fiber tested. A short length typically yields a higher absorption factor. Typical fiber lasers or amplifiers require at least 10 dB of pump absorption at a given pump wavelength to maximize the conversion efficiency toward the signal wavelength. The absorption factor is therefore better measured with a fiber length that would absorb 10 dB of pump power at the pump wavelength.

It is known in the art that breaking the circular symmetry of the cladding of an optical fiber can significantly decrease the amount of pump power travelling in helical modes. Octagonal claddings, such as for example shown in U.S. Pat. No. 6,157,763 (GRUBB et al), are known to improve the pump absorption. Such claddings have been demonstrated to provide absorption factor values higher than 0.8 in tests performed by the inventors. Other known methods proposed to break the circular symmetry of an optical fiber include using an off-center core (see U.S. Pat. No. 4,815,079 to SNITZER et al) or adding stress elements in the optical fiber (see U.S. Pat. No. 5,949,941 to DIGIOVANNI). Adding circular lobs at the cladding boundary has also been proposed by ANTHON et al (U.S. Pat. No. 6,411,762) and GRUBB et al (U.S. Pat. No. 6,157,763).

The above mentioned solutions however have some drawbacks. Octagonal or other polygonal claddings require shaping the fiber preform prior to drawing, or using an octagonal outer tube, both of which increase the processing time and complexity of the fiber manufacturing. Furthermore, due to the high temperatures used in the polishing and drawing steps, the octagonal shape ultimately obtained is typically rounded, which results in a reduction of the absorption factor compared to a sharper shape. To obtain a sharp octagon shape, the process must be limited to low temperatures, which limits the processing speed, as well as the quality of the resulting optical fiber. Also, the shaping of the fiber preform may induce a core-concentricity error in the resulting fiber.

Off-center cores are more difficult to align during the splice of the resulting fiber with other optical elements. The incorporation of stress elements adds fabrication and processing steps to the manufacturing of the fiber. Adding circular lobs at the cladding boundary involved incorporating rods in the fiber preform, requiring drilling of the preform, which also adds processing time. Furthermore, the resulting fiber is weakened as the transitions between the rods and the surrounding preform are prone to stress and lower mechanical resistance.

In view of the above there remains a need for an improved method of manufacturing a double-clad optical fiber or the like that alleviates at least some of the drawbacks of the prior art.

### SUMMARY

In accordance with one aspect, there is provided a method of manufacturing an optical fiber including:
a) providing a fiber preform comprising an active core and a pump-guiding cladding surrounding the core;
b) assembling one or more side rods to the fiber preform, therefore forming a fiber preform assembly, each of the side rods extending longitudinally along an outer surface of the pump-guiding cladding;
c) drawing the fiber preform assembly into said optical fiber such that each of the side rods defines a longitudinal protrusion extending along said pump-guiding cladding.

In some embodiments, the method the fiber preform may include at least one additional cladding between the pump-guiding cladding and the core.

The assembling of step b. include distributing a plurality of said side rods around the fiber preform, for example, 2, 3 or 4 such side rods. The distribution of the side rods around the fiber preform may be uniform or non-uniform.

In some embodiments, a ratio of a diameter of each side rod to a diameter of the fiber preform is larger than 0.02 and preferably larger than 0.05.

The assembling of step b. may involve fusing or partially fusing each of the side rods to the outer surface of the pump-guiding cladding. Alternatively or additionally, the assembling of step b. may involve providing a holder holding the side rods along the outer surface of the pump-guiding cladding.

The side rods are preferably made of a same material as the pump-guiding cladding, for example undoped silica.

In some embodiments, the drawing of step c. is performed at a temperature sufficient to fuse the one or more side rods to the outer surface of the pump-guiding cladding.

The method may include surrounding the optical fiber with at least one outer cladding, for example a polymer jacket.

In accordance with one aspect, there is provided an optical fiber manufactured by a variant of the method described above.

In accordance with yet another aspect, there is provided an optical fiber having an active core and a pump-guiding cladding surrounding the core and having an outer surface. The optical fiber further includes one or more longitudinal protrusions extending along the pump-guiding cladding. Each longitudinal protrusion has a cross-section forming a middle bump projecting radially away from the outer surface of the pump-guiding, cladding and smooth transition regions with the outer surface of the pump-guiding cladding on opposite sides of the middle bump.

The optical fiber may include at least one additional cladding between the pump-guiding cladding and the core, and/or at least one outer cladding surrounding the pump-guiding cladding.

In some implementations, the optical fiber includes a plurality of longitudinal protrusions distributed around the pump-guiding cladding, for example 2, 3 or 4 such longitudinal protrusions. The longitudinal protrusions may be uniformly or non-uniformly distributed around the pump-guiding cladding. In some embodiments, the longitudinal protrusions are made of a same material as the pump-guiding cladding, for example undoped silica.

In some implementations, each longitudinal protrusion has a cross-section forming a middle bump projecting radially away from the outer surface of the pump-guiding cladding and smooth transition regions with said outer surface of the pump-guiding cladding on opposite sides of said middle bump. The optical fiber may have a circular perimeter defined by the outer surface of the pump-guiding cladding, each longitudinal protrusion having a height ratio R defined by a radial height of the middle bump with respect to the circular perimeter of the optical fiber over a diameter of the optical fiber at said circular perimeter. In some embodiments, the height ratio R of each longitudinal protrusion is smaller than 0.20, and preferably smaller than 0.06. In some embodiments, the height ratio R of each longitudinal protrusion is larger than 0.001, and preferably larger than 0.03.

In some implementations the smooth transition regions of each longitudinal protrusion has a radius of curvature greater than 0.1 μm, and/or greater than a quarter of a radius of curvature of the outer surface of the pump-guiding cladding.

In some implementations, the optical fiber has a cladding pump absorption factor greater than 0.5, preferably greater than 0.8.

In some implementations, the optical fiber has a resistance to pulling or bending greater than 50 kpsi, preferably greater than 100 kpsi, and preferably greater than 200 kpsi.

In some implementations, stresses around each of the longitudinal protrusions are smaller than 200 MPa, 50 MPa, 10 MPa or 1 MPa.

In some implementations, the optical fiber has an average core-cladding concentricity error smaller than 0.4%.

Advantageously, embodiments of the method described herein provide optical fibers having a good absorption factor while being easy and quick to fabricate. Implementations of the method allow processing the fiber at high temperature during polishing and drawing and steps, which yields a continuous and smooth structure with low stress and little or no discontinuities in the cladding or at the cladding boundary.

Other features and advantages of the invention will be better understood upon a reading of preferred embodiments thereof with reference to the appended drawings.

### BRIEF DESCRIPTION OF THE DRAWINGS

FIGS. 1A to 1C illustrate step of a method of manufacturing an optical fiber according to one embodiment. FIG. 1A shows the providing of a fiber preform; FIG. 1B shows the assembly of side rods with the fiber preform while FIG. 1C shows the result of the drawing of the resulting fiber preform assembly.

FIGS. 2A to 2C schematically illustrate the cross-sectional shape of optical fibers according to embodiments.

FIG. 3A is a schematized cross-sectional view of an optical fiber according to one embodiment. FIG. 3B is an elevated side view of the optical fiber of FIG. 3A; FIG. 3C is an enlarged view of a portion of the fiber of FIG. 3A.

FIGS. 4A to 4D are images of optical fibers manufactured according to embodiments.

### DETAILED DESCRIPTION

The present description relates to a method of manufacturing optical fibers and to optical fibers resulting from such a manufacturing.

Embodiments of the method described herein provide optical fibers having an active core for light amplification and a pump-guiding cladding adapted to guide a pump light beam. As will be described further below, the optical fibers provided by the present method also include one or more longitudinal protrusions which break the circular symmetry of the fiber, and therefore improve the absorption factor and the absorption of pump power from the pump-guiding cladding in the active core.

It will be readily understood that implementations of the present method may be useful to make optical fibers for use in light-emitting devices. Such light-emitting devices may emit light and alternatively or additionally it may amplify light. The light-emitting device may be embodied by an amplifier or a pulsed amplifier, it may be embodied by a laser, a pulsed laser, an optical source of amplified spontaneously emitted (ASE) radiation, any continuous wave (CW) or quasi-continuous wave (quasi-CW) amplifier or laser, be it coherent or incoherent, or by any other means of amplification or generation (source) of light.

For example, a laser amplifies light by the stimulated emission of radiation. It includes a gain medium inside an optically cavity and means to supply, or pump, energy to the gain medium. The gain medium is a material with appropriate optical properties. The optical cavity causes the light to pass back and forth through the gain medium. Energy is pumped into the gain medium. This energy excites atoms in the gain medium to transition to a higher energy level, creating a population inversion. When light of an appropriate wavelength passes through the gain medium, the photons stimulate the excited atoms to emit additional photons of the same wavelength and to decay down to a lower energy level, resulting in an amplification of the light. An optical amplifier is similar to a laser, but does not have feedback from an optical cavity.

The term “light” is used to refer to all electromagnetic radiation, including but not limited to visible light. Furthermore, the term “optical” is used to qualify all electromagnetic radiation, that is to say light in the visible spectrum and light in other wavelength ranges.

Manufacturing Method

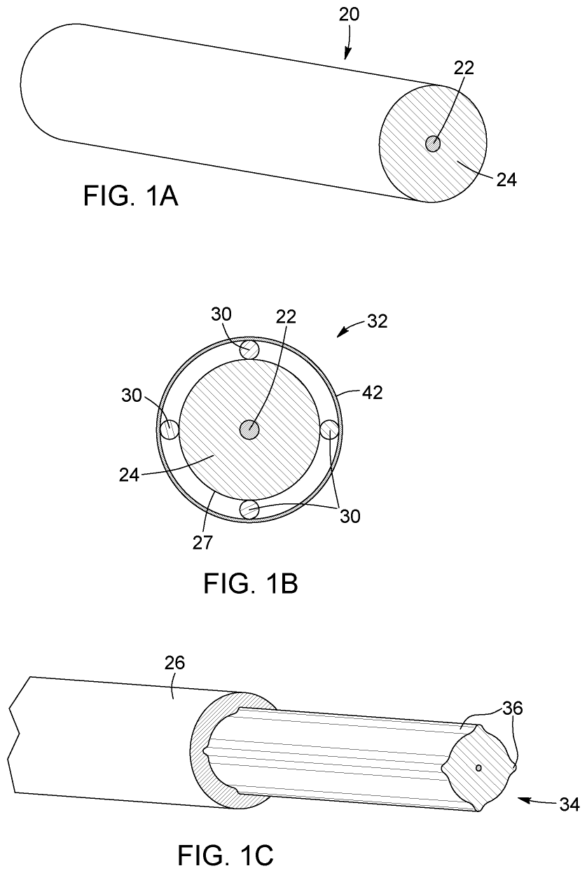

With reference to FIGS. 1A through 1C, step of a method of manufacturing an optical fiber 34 according to one implementation are schematically illustrated.

With particular reference to FIG. 1A, the method involves a first step of providing a fiber preform 20. The fiber preform includes an active core 22 and a pump-guiding cladding 24 surrounding the core 22.

It will be readily understood that the different layers of the fiber preform 20 are destined to define layers of the optical fiber 34 after the fiber preform 20 has been drawn. The resulting optical fiber 34 will therefore also have an active core 22 surrounded by a pump-guiding cladding 24. The structure shown in FIG. 1C defines a typical double-clad optical fiber, including, in addition to the core and pump-guiding cladding, an outer cladding 26 surrounding the pump-guiding cladding. The active core 22 provides amplification of light guided therealong while pump light is injected in the pump-guiding cladding 24 and guided by the interface between the pump-guiding cladding 24 and the outer cladding 26.

It will be readily understood that the expression “active core” is meant to refer to a light guiding structure in which stimulated emission of photons is produced from excitation of dopant ions by pump light. The active core 22 may be made of doped silica and is preferably doped with an active ion, for instance a rare-earth element such as thulium, ytterbium, erbium neodymium or a combination thereof. The active core can be doped with other non-active dopant such as aluminum, germanium, fluorine, boron, typically in the form of oxides.

The pump-guiding cladding 24 is adapted to receive and guide pump light, for the purpose of being absorbed by the dopant ions of the active core 22 and excite them to a higher energy state. The pump-guiding cladding 24 is preferably larger than the active core 22 in order to support high pump power. The pump-guiding cladding can for example be made of pure (undoped) silica, chalcogenide, fluoride or phosphate glass.

In typical embodiments the pump-guiding cladding 24 has a circular cross-section, the longitudinal protrusions described below therefore improving pump absorption by breaking this circular symmetry. However, in other implementations the fiber preform may have a different cross-sectional shape, with the longitudinal protrusions having a positive impact of the absorption factor nonetheless.

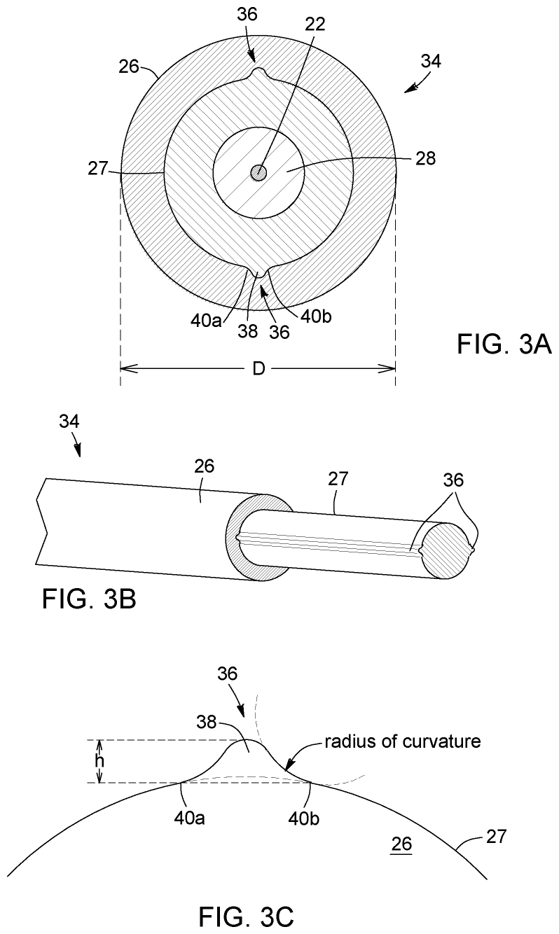

It will be further understood that the fiber preform 20, and therefore the optical fiber 34, may include additional layers to those illustrated in FIG. 1A without departing from the scope of the invention. Any suitable material can be used in these additional layers, such has for instance a low index polymer coating, a glass material, a liquid or even a gas. In some embodiments the fiber preform 20 may include at least one additional cladding 28 (see FIG. 3A) between the pump-guiding cladding 24 and the core 22, for example defining a triple-clad design. Other configurations may alternatively be considered.

Referring to FIG. 1B, the method next includes a step of assembling one or more side rods 30 to the fiber preform 20, therefore forming a fiber preform assembly 32. Each side rod 30 extends longitudinally along an outer surface 27 of the pump-guiding cladding 24.

In some embodiments the side rods 30 are distributed uniformly around the fiber preform, which leads to fewer core-splice losses when the resulting optical fiber is spliced to another fiber. Indeed, typical fusion splicers perform a cladding alignment of the two fibers being spliced using the outer edge of their respective claddings. If the side rods are not uniformly distributed, the outer edge may not be symmetric with respect to the core, which leads to a higher core-splice loss or excitation of higher order modes in the case of a multimode core.

In other implementations, the side rods 30 may be distributed non-uniformly around the fiber preform this approach may advantageously to further prevent cladding helical rays. Non-symmetric claddings improve mode mixing and pump absorption. This may yield to higher splice loss using cladding alignment, but this loss may not be important in some applications, or an active alignment of the core can be done using a light source and a power meter for instance to minimize the splice loss.

A plurality of side rods 30 may be provided, for example 2, 3, 4 or more such side rods, although in some implementations a single side rod may be provided without departing from the scope of the invention.

The side rods 30 are preferably made of a same material as the pump-guiding cladding 24 of the fiber preform 20, for example undoped silica, chalcogenide, fluoride or phosphate glass.

The side rods 30 are preferably circular, due to the simplicity of fabrication and assembly of such rods. However, in other implementations side rods 30 of different cross-sectional shapes may be used, such as for example square, triangle, rectangle, half circle, etc. In some implementations the ratio of the diameter of each side rod 30 to the diameter of the fiber preform 20 is larger than 0.02, and preferably larger than 0.05.

The assembling of the side rods 30 to the fiber preform 20 may be performed in a variety of manners. In some implementations each the side rod 30 may be fused or soldered to the outer surface 27 of the pump-guiding cladding 24. The fusing of the side rods 30 to the fiber preform 20 may be performed along substantially their entire length or partially, at one or more locations along the fiber preform 20.

In other implementations, such as for example shown in FIG. 1B, a holder 42, such as a clamp or the like, may be provided for holding the side rods 30 along the outer surface 27 of the pump-guiding cladding 24, either in direct contact with the outer surface or in close proximity thereto. In yet another implementation the side rods 30 may be manually held in place against the pump-guiding cladding 24 during the drawing process explained below. The side rods may also be held separately from the preform and be fused to the fiber during the drawing process.

Referring to FIGS. 1B and 1C, the method next includes a step of drawing the fiber preform assembly 32 into the optical fiber 34, such that each of the side rods 30 defines a longitudinal protrusion 36 extending along the optical fiber 34.

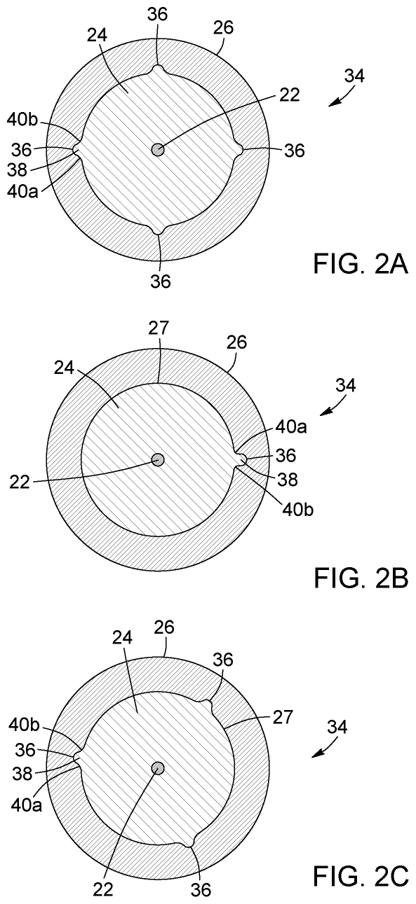

The drawing of the preform assembly 32 may be performed according to techniques well known in the art, using a drawing tower and/or related apparatuses suited for the manufacturing of optical fiber. Preferably, the drawing of the optical fiber 34 is performed at a temperature sufficient to fuse the side rods 30 to the outer surface 27 of the pump-guiding cladding 24, in particular if the side rods 30 have not been fused to the fiber preform 20 at the assembling step. Preferably, the size of the side rods 30 and the drawing temperature are chosen such that side rods 30 are highly fused to the pump-guiding cladding 24 with no discontinuities therebetween. The resulting cross-section of the optical fiber 34 according to different variants is illustrated in FIGS. 2A to 2C, respectively showing optical fibers with 4, 1 and 3 longitudinal protrusions 36, fused to the outer surface 27 of the pump-guiding cladding 24 to varying degrees. Each longitudinal protrusion 36 has a cross-section forming a middle bump 38 projecting radially away from the outer surface 27 of the pump-guiding cladding 24 and smooth transition regions 40a, 40b with the outer surface 27 of the pump-guiding cladding 24 on opposite sides of this middle bump 38. It will be readily understood that the expression “projecting radially away” refer to the fact that the longitudinal protrusions 36 extend outwardly of the outer surface 27 of the pump-guiding cladding 24, as they have been fabricated without making any holes in the pump-guiding cladding 24 or other portions of the optical fiber. Furthermore, the expression “smooth transition regions” is understood to refer to zones at the junctions between the middle bump 38 and the outer surface 27 of the pump-guiding cladding 24 which is free of major discontinuities. Advantageously, the provision of such longitudinal protrusions 36 reduces the stress at the interface with the pump-guiding cladding 24 compared to prior techniques described above. Furthermore, by avoiding discontinuities the mechanical resistance of the fiber is improved and the cleaving of the resulting fiber 34 to other optical components is facilitated.

Preferably, the method includes surrounding the optical fiber 34 with at least one outer cladding 26. The outer cladding 26 is preferably made of a low refractive index material in order to allow guidance of the pump power in the pump-guiding cladding 24. For example, the outer cladding can be added during the drawing by adding a low index polymer using dye on the drawing tower. In another example, an outer cladding 26 made of a lower index than the cladding can be added on the preform such as fluorine doped silica prior to drawing. In one example the outer cladding 26 may be embodied by an acrylate or polymer jacket surrounding the optical fiber.

Advantageously, embodiments of the method described herein allow the drawing of fiber preforms of large dimension with low tension while still obtaining an improved absorption factor compared to other known techniques. For example, an absorption factor higher than 0.5, and ever higher than 0.8 can be obtained by drawing the fiber preform with a pulling tension lower than 100 gram-force (gf), 50 gf and even 25 gf. Preforms diameter larger than 10 mm, 30 mm and even 50 mm can be drawn with an absorption factor higher than 0.5 to 0.8.

Advantageously, no drilling is required in carrying out the method described herein, as the side rods are fused directly onto the pump-guiding cladding. This feature alleviates a drawback of prior art methods, as drilling a glass preform can be challenging—ultrasonic drilling is typically required, which cannot be done easily on long preforms and can result in a low surface quality. Drilling holes close to the sides the preform is prone to glass breakage and chipping. Furthermore, good tolerance of the rods inserted in the hole is required and care must be taken to avoid bubbles at the interface between the rods and the preform, weakening the resulting fiber. Finally, rods inserted in the preform are likely to cause a discontinuity at the boundary of the pump-guiding cladding, which is also a source of structural weakness.

Optical Fiber

In some implementations, there is provided an optical fiber manufactured according to an embodiment of the method described above. The optical fiber can be made of any type of glass such as silica, fluoride, chalcogenide, or phosphate. The fiber could be microstructure, a photonics bandgap fiber, a triple clad design or consists of several claddings or regions to guide pump light.

Referring to FIGS. 3A to 3C, there is shown an example of an optical fiber 34 according to one aspect. The optical fiber 34 includes an active core 22, a pump-guiding cladding 24 surrounding the active core 22 and an outer cladding 26 surrounding the pump-guiding cladding 24. As mentioned above, the active core 22 may be made of doped silica, and is preferably doped with an active ion, for instance a rare-earth element such as thulium, ytterbium, erbium neodymium or a combination thereof. The pump-guiding cladding 24 is preferably made of undoped silica. The outer cladding 26 is preferably made of a low refractive index material in order to allow guidance of the pump power in the pump-guiding cladding 24. In some example the outer cladding 26 may be embodied by an acrylate jacket surrounding the optical fiber.

The optical fiber 34 may include additional layers to those listed above. For example, in the embodiment of FIGS. 3A to 3C the optical fiber 34 includes an additional cladding 28 between the pump-guiding cladding 24 and the core 22, defining a triple-clad or pedestal design. Other configurations may alternatively be considered. Any suitable material can be used in these additional layers, such as for instance a low index polymer coating, a glass material, a liquid or even a gas.

The optical fiber 34 further includes one or more longitudinal protrusions 36 extending along the pump-guiding cladding 24. Each longitudinal protrusion 36 has a cross-section forming a middle bump 38 projecting radially away from the outer surface 27 of the pump-guiding cladding 24 and smooth transition regions 40a, 40b with this outer surface 27 on opposite sides of the middle bump 38.

Although only 2 longitudinal protrusions are shown in the embodiment of FIGS. 3A and 3B, it will be readily understood that in other variant 3, 4 or more such longitudinal protrusions may be used. In some variants a plurality of longitudinal protrusions are distributed around the pump-guiding cladding, uniformly or non-uniformly. In other embodiments a single longitudinal protrusion may be provided.

The longitudinal protrusions are preferably made of a same material as the pump-guiding cladding, for example undoped silica, chacogenide, phosphate or fluoride.

Parameters defining the geometry of the optical fiber 34 include the circular perimeter P_{fiber}, defined by the contour of the cross-section of the outer surface 27 of the pump-guiding cladding 24. As its name entail the circular perimeter is typically circular, although in some variants the contour of the pump-guiding cladding may have a different shape. The radial height h of the middle bump 38 is typically measured from the top edge of the middle bump 38 to the circular perimeter of the outer surface 27 of the pump-guiding cladding, as shown in FIG. 3C. In some implementations, each longitudinal protrusion 36 has a height ratio R, defined by the radial height h of the middle bump 38 over the diameter D of the optical fiber at the circular perimeter, that is smaller than 0.20, and preferably smaller than 0.06, to facilitate the application of the lower refractive index material constituting the outer cladding and easy cleaving. However, a longitudinal protrusion with a radial height h that is too small with respect to the size of the optical fiber may not be efficient in increasing the absorption factor, and a height ratio R larger than 0.001 is typically sought to obtain an absorption factor higher than 50%. A height ratio R larger than 0.03 may provide an absorption factor larger than 0.8. If the longitudinal protrusion is made of a different material than that of the pump-guiding cladding or with a material having a different index of refraction, a highly fused longitudinal protrusion with a value smaller than 0.1% of the fiber diameter can give an absorption factor higher than 50%; even a totally fused protrusion in the fiber (R≈0) could give an absorption factor higher than 50% when using a different material than the pump-guiding cladding.

Preferably, the transition regions 40a and 40b have no or negligible discontinuities with the surrounding pump-guiding cladding 24 in order to reduce local stresses. In some implementations the smooth transition regions 40a, 40b of each longitudinal protrusion 36 has a radius of curvature greater than 0.1 μm. FIG. 3C shows where the radius of curvature is measured. In other variants the radius of curvature of the longitudinal protrusions 36 is greater than a quarter of a radius of curvature of the outer surface 27 of the pump-guiding cladding 24.

Preferably, the design of the longitudinal protrusions 36 provides a cladding pump absorption factor greater than 0.5, and preferably greater than 0.8.

In some implementations, the optical fiber 34 has a good mechanical resistance. Preferably, the optical fiber 34 has a resistance to pulling or bending, as determined by a minimum resistance proof-test, of at least 50 kpsi, and preferably greater than 100 kpsi, or greater than 200 kpsi. An optical fiber with low stress is also desired, especially compared to stresses induced by the shaping process of prior art fibers. The method described herein allows the manufacture of optical fibers with stress lower than 200 MPa at the interface between the cladding 24 and the longitudinal protrusions 36, or in the region around the longitudinal protrusions. Preferably, stresses around each of the longitudinal protrusions are smaller than 200 MPa, or smaller than 50 MPa, or smaller than 10 MPa, or smaller than 1 MPa.

The method described above decreases the core-cladding concentricity error E of the resulting optical fiber compared to other methods such as shaping the preform with a given numbers of sides (e.g. octagonal). In some implementations, the resulting optical fiber 34 has an average core-cladding concentricity error E smaller than 0.4% during the manufacturing process, especially for preform diameter smaller than 30 mm.

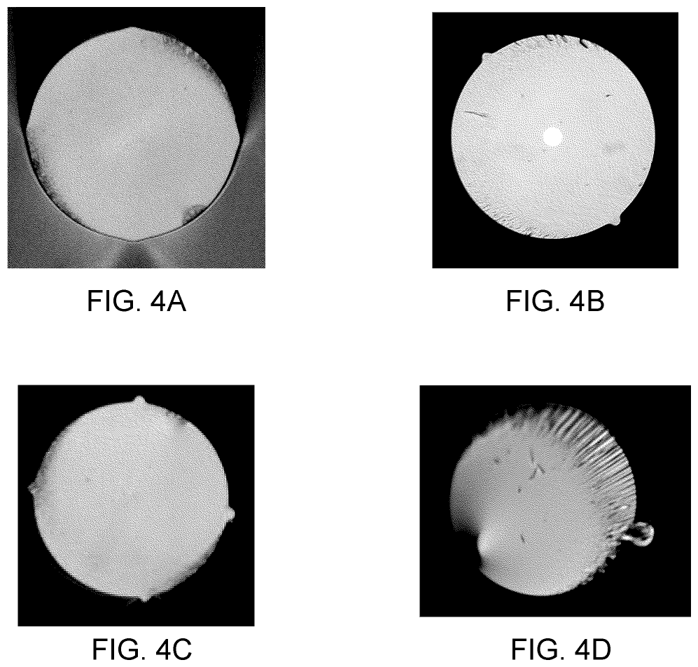

Referring to FIGS. 4A to 4D, there are shown images of optical fibers according to embodiments, in cross section. FIG. 4A shows an optical fiber having 4 longitudinal protrusions that are highly fused to the pump-guiding cladding. In FIG. 4B, only two larger longitudinal protrusions fused to the cladding to a lesser degree. FIG. 4C shows 4 longitudinal protrusions non-uniformly distributed around the cladding to maximise the absorption factor. Finally, FIG. 4D shows a single longitudinal protrusion resulting from a large side rod barely fused to the pump-guiding cladding.

Of course, numerous modifications could be made to the embodiments described above without departing from the scope of the invention as defined in the appended claims.

1. A method of manufacturing an optical fiber, comprising:
a) providing a fiber preform comprising an active core and a pump-guiding cladding surrounding the core;
b) assembling one or more side rods to the fiber preform, therefore forming a fiber preform assembly, each of the side rods extending longitudinally along an outer surface of the pump-guiding cladding; and
c) drawing the fiber preform assembly into said optical fiber such that each of the side rods defines a longitudinal protrusion extending along said pump-guiding cladding.

2.-4. (canceled)

5. The method according to claim 1, wherein the assembling of step b comprises distributing the plurality of said side rods non-uniformly around the fiber preform.

6. (canceled)

7. The method according to claim 1, wherein a ratio of a diameter of each side rod to a diameter of the fiber preform is larger than 0.02.

8. (canceled)

9. The method according to claim 1, wherein the assembling of step b. comprises fusing each of the side rods to the outer surface of the pump-guiding cladding.

10. The method according to claim 1, wherein the assembling of step b. comprises partially fusing each of the side rods to the outer surface of the pump-guiding cladding.

11. The method according to claim 1, wherein the assembling of step b. comprises providing a holder holding the side rods along the outer surface of the pump-guiding cladding.

12.-13. (canceled)

14. The method according to claim 1, wherein the drawing of step c is performed at a temperature sufficient to fuse the one or more side rods to the outer surface of the pump-guiding cladding.

15. The method according to claim 1, further comprising surrounding the optical fiber with at least one outer cladding.

16.-21. (canceled)

22. An optical fiber manufactured by the method according to claim 1.

23. The optical fiber according to claim 22, wherein each longitudinal protrusion has a cross-section forming a middle bump projecting radially away from the outer surface of the pump-guiding cladding and smooth transition regions with said outer surface of the pump-guiding cladding on opposite sides of said middle bump.

24. The optical fiber according to claim 23, wherein the optical fiber has a circular perimeter defined by the outer surface of the pump-guiding cladding, each longitudinal projection has a height ratio R defined by a radial height of the middle bump with respect to the circular perimeter of the optical fiber over a diameter of the optical fiber at said circular perimeter, said height ratio R of each longitudinal protrusion being smaller than 0.20.

25. The optical fiber according to claim 24, wherein the height ratio R of each longitudinal protrusion is smaller than 0.06.

26.-27. (canceled)

28. The optical fiber according to claim 23, wherein the smooth transition regions of each longitudinal protrusion have a radius of curvature greater than 0.1 m.

29. (canceled)

30. The optical fiber according to claim 22, having a cladding pump absorption factor greater than 0.5.

31.-32. (canceled)

33. The optical fiber according to claim 22, having a resistance to pulling or bending greater than 100 kpsi.

34. (canceled)

35. The optical fiber according to claim 22, wherein stresses around each of the longitudinal protrusions are smaller than 200 MPa.

36.-38. (canceled)

39. The optical fiber according to claim 22, having an average core-cladding concentricity error smaller than 0.4%.

40. An optical fiber comprising:
an active core;
a pump-guiding cladding surrounding the core and having an outer surface; and
one or more longitudinal protrusions extending along said pump-guiding cladding, each longitudinal protrusion having a cross-section forming a middle bump projecting radially away from the outer surface of the pump-guiding cladding and smooth transition regions with said outer surface of the pump-guiding cladding on opposite sides of said middle bump.

41.-43. (canceled)

44. The optical fiber according to claim 42, wherein the plurality of longitudinal protrusions are non-uniformly distributed around the pump-guiding cladding.

45.-52. (canceled)

53. The optical fiber according to claim 40, wherein the smooth transition regions of each longitudinal protrusion have a radius of curvature greater than 0.1 m.

54.-64. (canceled)
